(19) United States
(12) Patent Application Publication
(10) Pub. No.: US 2007/0042727 A1
(43) Pub. Date: Feb. 22, 2007

(54) Systems and methods for voice and data communication

(75) Inventor: Rolf Stefani, West River, MD (US)

Correspondence Address: OLIFF & BERRIDGE, PLC, P.O. BOX 19928, ALEXANDRIA, VA, 22320, US

(73) Assignee: ARINC INC., Annapolis, MD (US)

(21) Appl. No.: 11/204,114

(22) Filed: Aug. 16, 2005

(51) Int. Cl. H04B 1/04

(52) U.S. Cl. 455/121

(57) ABSTRACT

Disclosed systems and methods are directed to an ability to use a portable data storage and display device to communicate via communication satellites with remote receiving nodes by incorporating, attached to, located within, or locally in data communication with, the device, a satellite communication transceiver. Direct access to virtually any communication technology from a portable data storage and display device to provide voice and data communications with receiving nodes of differing capabilities, which include autonomous direct satellite communication capability, is effected. A user may be provided a graphical display by which to initiate transmission and/or reception of voice and data communications via a communications and control application which provides the user an ability to manually select, or to direct the system to automatically select, a desired or available communication path by which to effect transmission and reception of voice and data communications including direct access to satellite links. Class 1 or 2 certified EFB devices may be adapted with the disclosed systems and methods to facilitate all voice and data communications from an aircraft.

### BACKGROUND

This disclosure, and related U.S. Patent Application No. (Attorney Docket No. 123853) by the same inventor, filed on even day herewith, are directed to systems and methods for integrated voice and data communications and control, including a satellite communication capability implemented via a portable satellite communication transceiver in communication with a portable data storage and display device, such as an Electronic Flight Bag (EFB).

U.S. patent application Ser. Nos. 10/919,318, 10/971,104 and 11/181,991, by the same inventor and commonly assigned, are incorporated herein in their entirety by reference. These applications generally teach the use of portable data storage and display devices, to streamline, make more efficient, and/or make safer, operations that require relatively immediate access to a particular individual data reference page contained in volumes of stored data reference pages, which could number in the tens of thousands of such individual pages, particularly in high task-loading environments. The above-described applications are directed to, for example, Electronic Flight Bags (EFBs) that are carried in the cockpits of commercial airliners and other modern aircraft. EFBs can be advantageously employed to provide integrated, user-friendly, interactive platforms to coordinate many routine tasks requiring access to data for time-critical recall and manipulation and/or for crew coordination.

The above-referenced applications explain that the introduction of EFBs into the cockpits of aircraft provide an automated and interactive library of publications, in electronic format, to replace the conventional flight bag full of checklists, charts, publications and the like. Specific reference pages are provided as may be required for aircraft operations from startup to shutdown and may include, for example, individual airport diagrams, airport run approach and/or departure procedures, various en route navigation-specific charts, procedural checklists, aircraft operating manuals, tables of operating limitations and/or other pertinent or required information publications. An EFB is usable to display information that supports safe and efficient conduct of a flight from preflight through postflight.

### SUMMARY

U.S. patent application Ser. No. 11/181,991 adapts a portable data storage and display device, of which an EFB is an example, to implement a single integrated communicating and communication control device to facilitate transmitting and receiving voice communications. For example, the communications may incorporate Voice-over-IP (VoIP) services and a wireless fidelity (WiFi) communications link when an aircraft is on the ground and within the footprint of, for example, a WiFi communications network located on or around an airport.

It would be advantageous to employ expanding technologies in varying combinations to further extend voice and other forms of data communications from a single integrated device that is primarily designed and constructed as a data reference device.

Various exemplary embodiments of disclosed systems and methods may include the ability within a data storage and display device to communicate via communications satellites with remote receiving nodes by incorporating, e.g. attached to, or located within, the device, a satellite communication transceiver.

In various exemplary embodiments, a satellite communication transceiver may be provided as a separate unit positioned in proximity to a portable data storage and display device and with which the portable storage and display device may wirelessly communicate.

Various exemplary embodiments of disclosed systems and methods may provide direct access to virtually any communication technology from a portable data storage and display device to provide voice and data communication with receiving nodes of differing capabilities, which may include an autonomous direct satellite communication capability.

Various exemplary embodiments of disclosed systems and methods may provide a user with a graphical display, or graphical user interface, to enable a user to initiate transmission and/or reception of voice and data communications via a communication and control application which may provide an ability for the user to manually select, or to direct the system to automatically select, a desired or available communication path by which to effect transmission and reception of voice and data communications from among a plurality of available communication paths, including direct access to satellite links from the device.

Various exemplary embodiments of disclosed systems and methods may enhance safe and effective communication of voice and data with differing receiving nodes, as needed, in real time, by providing a capability for a user to select the most efficient communication path by which to effect voice and/or data communications.

Various exemplary embodiments of disclosed systems and methods may find particular advantage in incorporation in Class 1 or 2 certified EFB devices which can be accommodated in the cockpits of commercial airliners and other modern aircraft to provide a single unit by which all voice and data communications from the cockpit may be effected.

Exemplary embodiments of disclosed systems and methods may be described herein to refer to a specific application of voice and data communications between a flight crew member of an aircraft and various communication receiving nodes with which the flight crew member may routinely communicate. Further, the exemplary embodiments may describe a manner in which voice and/or data communications may be facilitated by employing a portable data storage and display device such as, for example, an EFB, to coordinate and/or control the communications particularly through a voice and data communication and control application stored in, and/or executable through, an EFB device. Such communications may be transmitted and received, for example, across any manually or automatically selectable communication path, to include direct satellite communications effected from and/or through the device based on the incorporation of a satellite communication transceiver with the portable data storage and display device. Such incorporation may be undertaken without adversely affecting portability of the device. Alternatively, a portable unit comprising the satellite communication transceiver may be provided with which the portable data storage and display device may wirelessly communicate to effect satellite communications. The disclosed systems and methods, however, should not be construed as limited to the descriptions of the exemplary embodiments, or reference to any individual application for such embodiments, as described herein. Rather, the systems and methods described in this disclosure should be construed as being usable in virtually any application where a portable and/or handheld device may be used to effect voice and data communications via a plurality of communicative paths, to include direct satellite communication access for transmission and reception.

These and other features and advantages are described in, or apparent from, the following detailed description of various exemplary embodiments of disclosed systems and methods.

### BRIEF DESCRIPTION OF THE DRAWINGS

Various exemplary embodiments of disclosed systems and methods will be described, in detail, with reference to the following figures, wherein:

FIG. 1 illustrates an exemplary embodiment of a voice and data communications system to facilitate voice and data communications controlled and coordinated through a portable data storage and display device, such as an EFB, to include direct satellite communications;

FIG. 2 illustrates a block diagram of an exemplary embodiment of a generic portable data storage and display device, of which an EFB is one example, usable to implement the disclosed systems and methods for facilitating voice and data communications to include direct satellite communications; and

FIG. 3 illustrates an exemplary embodiment of a portable satellite communication transceiver unit usable with disclosed systems and methods.

### DETAILED DESCRIPTION OF EMBODIMENTS

The following description of various exemplary embodiments will describe systems and methods for implementing voice and data communications from a portable data storage and display device by incorporating a satellite communication transceiver as a system with, or in, the portable data storage and display device. This voice and data communications and control capability will be described as resident in, or implemented through, for example, an Electronic Flight Bag (EFB). The discussion will focus on currently available EFB devices that may be adapted for the coordination of voice and data communications, as well as for the ability to manually or automatically select from among a plurality of communication paths, including a satellite communication path, over which the EFB is configured and/or adapted to communicate. However, the disclosed principles, as outlined and/or discussed below, are not to be narrowly construed as pertaining to any single application. The disclosed systems and methods may find equal utility with any known or later-developed portable and/or handheld, electronic, and/or digital, data storage and display device which can be adapted with at least an audio input/output capability and a satellite communication transceiver for facilitating communication via satellites directly from the device.

Exemplary embodiments of disclosed systems and methods may leverage currently available capabilities by incorporating, for example, an Iridium L-band transceiver within a Class 1 or 2 certified EFB and incorporating appropriate software or hardware elements to facilitate selecting an individual communication path from among a plurality of available communication paths, and formatting voice or data transmissions to be compatible with the selected communication path. Such applications may expand the capabilities of the current state-of-the-art EFB suite of products to include effecting virtually all voice and data communications through a single data reference storage device. The descriptions of the exemplary embodiments below are intended to be illustrative and not limiting.

U.S. patent application Ser. No. 11/181,991 describes, in detail, a voice communication and control capability implemented through a portable data storage and display device. This disclosure includes an expansion of some of the concepts presented in U.S. patent application Ser. No. 11/181,991. As such, exemplary embodiments described in that reference may be adapted to enhanced capabilities according to the systems and methods of this disclosure. Detailed depiction and/or description of exemplary implementations from U.S. patent application Ser. No. 11/181,991 are not repeated here.

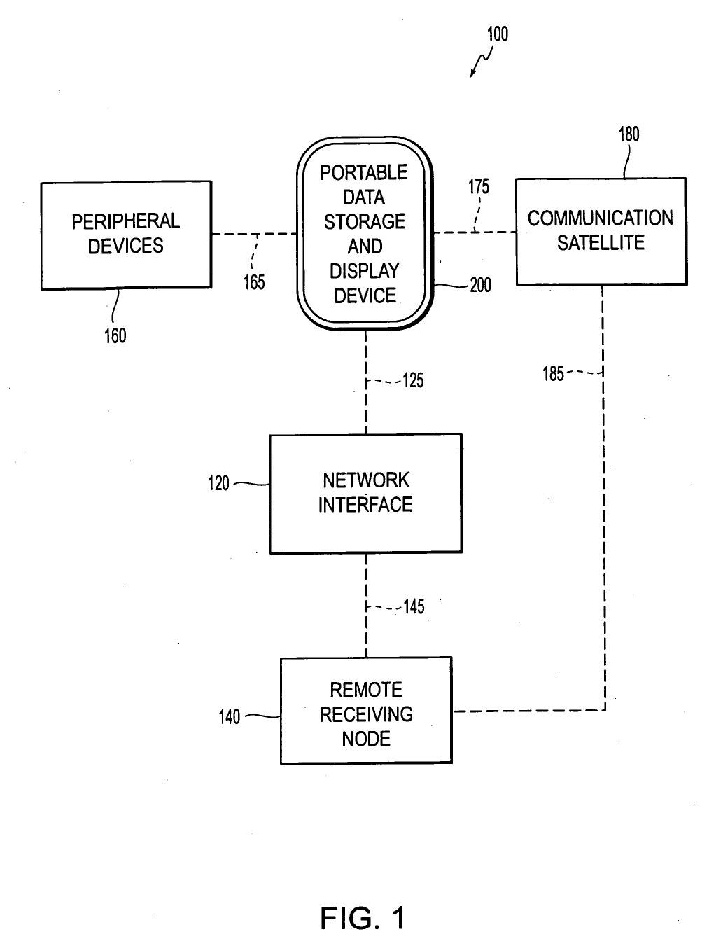

FIG. 1 illustrates an exemplary embodiment of a voice and data communications system to facilitate voice and data communications controlled and coordinated through a portable data storage and display device, such as an EFB, to include direct satellite communication. As shown in FIG. 1, the system 100 includes a portable data storage and display device 200, of which an individual user's Electronic Flight Bag (EFB) is an example. The portable data storage and display device 200 may be connectable to a network interface 120 via a communication path 125. This network interface 120 may be further connectable to any one of a plurality of remote receiving nodes 140 by a separate communication path 145.

It should be appreciated that although depicted as a separate element, the data communication network interface device 120 may be incorporated within the portable data storage and display device 200, or may be resident within one or more of the plurality of remote receiving nodes 140. In such an instance, the individual communication paths 125, 145 would likely be a single communication path between the portable data storage and display device 200 and the remote receiving node 140.

Further, it should be appreciated that the data communication paths 125, 145, whether a plurality of connections as depicted or a single connection as discussed above, may include any form of wired or wireless or optical communication connections, or any combination of those, between communicating elements.

In some embodiments, network interface 120 may include only a wireless and/or satellite communication (SATCOM) antenna.

The portable data storage and display device 200 may also be connectable to one or more peripheral devices 160 via separate wired, wireless or optical communication paths 165. These peripheral devices may include, but are not limited to, separate data storage elements, separate data recording devices for, for example, downloading data to or uploading data from, or other devices which may be supported and/or controlled by the portable data storage and display device 200, or which may support the portable data storage and display device 200.

As will be shown below, in exemplary embodiments of the disclosed systems and methods, a voice and data communications capability is available based on inclusion in the system of a portable satellite communication transceiver. The inclusion of the satellite communication transceiver in the system may involve (1) incorporating the satellite communication transceiver with or within the portable data storage and display device 200, or (2) providing a separate satellite communication transceiver unit in close proximity to and in communication with the portable data storage and display device 200. This satellite communication transceiver is included to provide a direct communication capability whereby voice and data communications may be effected through one or more communication satellites 180 across satellite communication paths 175, 185 between the portable data storage and display device 200 and the plurality of remote receiving nodes 140 via one or more satellites 180.

As noted above, and as will be described in more detail below, this satellite communication transceiver may be incorporated with or within the portable data storage and display device 200 without appreciably altering the portability of such a device. Further, as will be described in further detail below, software applications and/or hardware/firmware circuitry may be included to facilitate voice and data communications via the satellite communication transceiver and associated satellite communication links.

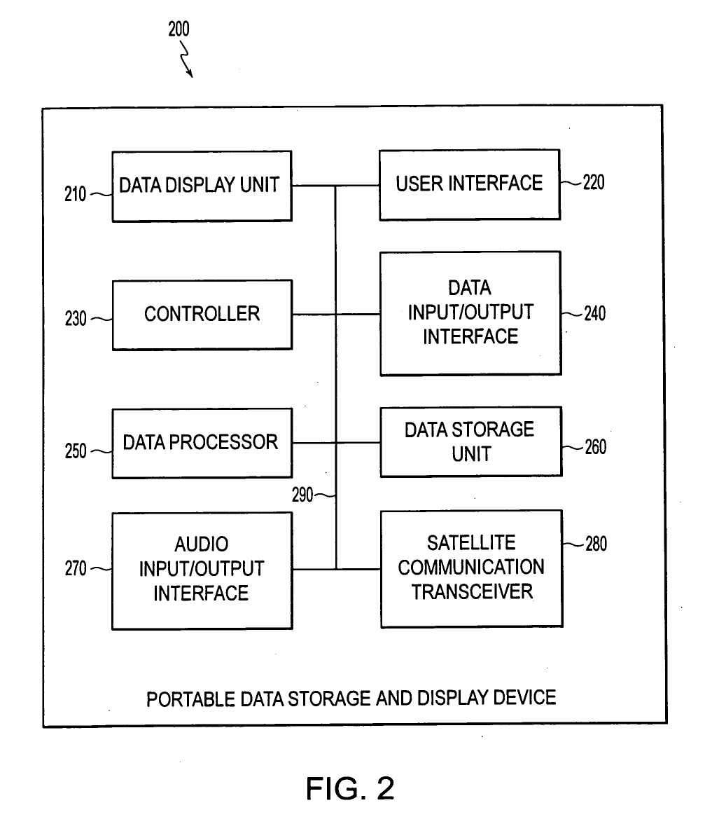

FIG. 2 illustrates a block diagram of an exemplary embodiment of a generic portable data storage and display device 200, of which an EFB is one example, usable to implement the disclosed systems and methods for facilitating voice and data communications, to include direct satellite communication.

In the following discussion, a generic data storage and display device 200 is described with reference to FIG. 2. It should be appreciated that, however, an EFB, such as that disclosed, described and depicted in exemplary form in the above-identified three patent applications which are incorporated herein by reference, is contemplated as an exemplary embodiment of a portable data storage and display device 200. Other exemplary portable data storage and display units 200 may include, but not be limited to, portable computers (referred to alternatively as laptop or notebook computers), personal digital assistants (PDAs), electronic notebooks or any other known or later-developed portable data storage and display device. The portable data storage and display devices preferably have no dimension larger than about 12 inches, or about 10 inches, or about 6 inches, and preferably have at least one dimension no greater than about 2 inches, or about 1 inch. The portable data storage and display devices preferably weigh less than about 10 pounds, or less than about 7 pounds, or less than about 3 pounds.

The exemplary portable data storage and display device 200 depicted in FIG. 2 includes a data display unit 210, a user interface 220, a controller 230, a data input/output interface 240, a data processor 250, at least one data storage unit 260, an audio input/output interface 270, and a satellite communication transceiver 280. Each of these components may be interconnected via a data/control bus 290.

Various exemplary embodiments of disclosed systems and methods may employ any manner of speaker and microphone combination wired to, or otherwise communicating with, a compatible connection in the audio input/output interface 270. Such speaker and microphone combination may include, for example, an internal or external microphone, at least one internal or external speaker, a compatible connection to provide audio input to and receive audio input from a headset including earphones and a microphone, such as, for example, a flight crew member's headset, or any other like devices to facilitate voice communication with and/or other audio input to and output from, the portable data storage and display device 200 via the audio input/output interface 270.

The data processor 250 may be available to execute the voice and data communications and control capability by, for example, being loaded with a software application that facilitates voice and data communications and control of those communications. The data processor 250 may convert input audio signals received from a microphone via the audio input/output interface 270 of the portable data storage and display device 200 to a data packet or signal for transfer to a network via the data input/output interface 240 over any of a plurality of forms of data communication devices. Based on the receipt of data from a data source via the data input/output interface 240, the data input/output interface 240 may automatically, via the data processor 250, or otherwise, initiate a software application to modify the received data to a form to be delivered via the audio input/output interface 270 to a speaker (not shown). Incoming voice or data transmission from any source, via any communication path, addressed to the portable data storage and display device 200 may cause the data processor 250 to initiate processing of the incoming data for presentation in an appropriate form, for example, as a display on the data display unit 210, or as an audio output via the audio input output interface 270, as noted above.

Operations of the portable data storage and display device 200 may be controlled by the controller 230, and information may be displayed to the user on the data display unit 210. Processes resident in the portable data storage and display device 200 may be manipulated via the user interface 220. Also, the user interface 220, although depicted as a separate unit, may be incorporated into the data display unit 210, for example, as a touch-screen display or other graphical user interface to facilitate user input.

The controller 230 may also be available to provide selection of, or switching between, the data input/output interface 240 or the satellite communication transceiver 280, which will be described in more detail below. Such selection, executed through the controller 230, may be automatic based on, for example, a stored hierarchy by which the controller 230, autonomously, or in combination with the data processor 250, may choose between respective output interfaces. Alternatively, a user, via the user interface 220, for example, may be provided the option to command which of the communication paths, i.e., the data input/output interface 240 or the satellite communication transceiver 280, is selected. Separately, the form and/or source of the voice or data communications received by the portable data storage and display device 200 may indicate and/or direct the selection of the communication path.

In exemplary embodiments of the disclosed systems and methods, enhancements to the voice and data communications capabilities available in a portable data storage and display device 200 may be provided by including with the portable data storage and display device 200 a satellite communication transceiver 280. It should be appreciated that incorporation of such a device or unit, located within, or attached to, the portable data storage and display device 200, may occur without impact on the portability of the portable data storage and display device 200. In other words, any incorporation of an exemplary satellite communication transceiver 280 by, for example direct attachment to, or housing within, the portable data storage and display device 200 is contemplated to be available within the current structures and casing sizes of such exemplary portable data storage and display devices 200, or in portable attachment to such structure or casing. In exemplary embodiments therefore, for example, Iridium L-band satellite transceivers may be incorporated with, or within, a portable data storage and display device 200, such as an EFB, based on their small size. The satellite transceiver 280 preferably has no dimension larger than about 6 inches, or about 4 inches, and preferably has one dimension no greater that about 1 inch.

In exemplary embodiments, a satellite transceiver may alternatively be provided in a separate unit in proximity to, and in data communication with, e.g. via a wired, wireless, optical or other data communication path, the portable data storage and display device 200.

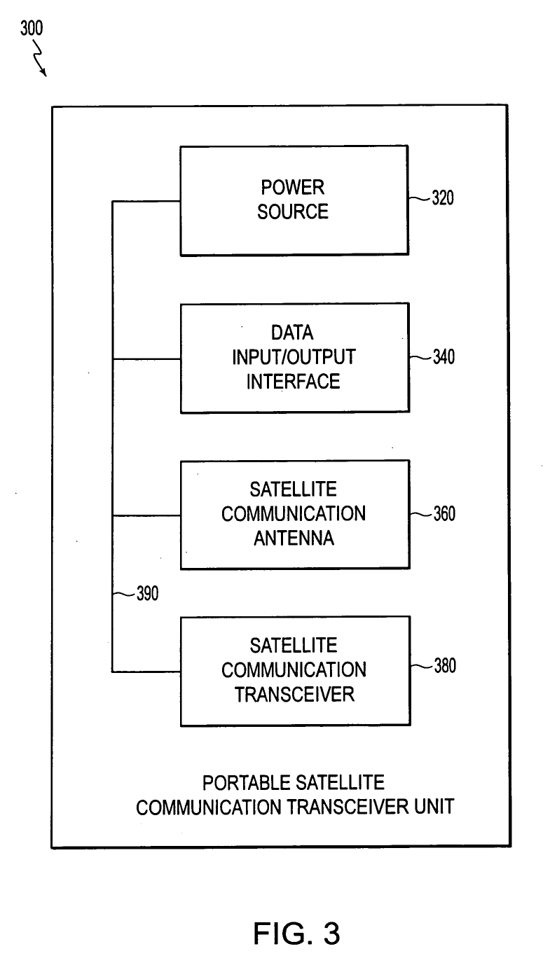

FIG. 3 illustrates an exemplary embodiment of a portable satellite communication transceiver unit 300 usable with disclosed systems and methods. As shown in FIG. 3, a portable satellite transceiver unit 300 may include a power source 320, a data input/output interface 340, a satellite communication antenna 360, and a satellite communication transceiver 380. These components may be interconnected as appropriate by one or more data/power busses 390.

The satellite communication transceiver 380 functions in the same manner as the satellite communication transceiver 280 of FIG. 2 described above to facilitate direct communication with one or more communication satellites 180 of FIG. 1. Data may be sent from the data input/output interface 240 of a portable data storage and display device 200 (see FIG. 2) to, for example, the data input/output interface 340 to be passed to the satellite communication transceiver 380. Data communication between the portable data storage and display device may be by any path such, for example, wired, wireless or optical data transmission. The data may be provided in a form whereby it can be simply transmitted by the satellite communication transceiver 380 based on keying or cueing by the portable data storage and display device. Otherwise, the satellite communication transceiver may include a processing routine, device or unit that properly formats the data for satellite transmission, and/or formats incoming satellite communication to be compatible with the portable data storage and display device with which the portable satellite communication transceiver unit 300 is communicating.

Information and processes required to support voice and data communications and control may be resident within the exemplary portable data storage and display device 200, shown in exemplary manner in FIG. 2, of which an EFB is an example.

Any data storage contemplated for the various disclosed exemplary embodiments may be implemented using an appropriate combination of alterable memory or fixed memory. The alterable memory, whether volatile or non-volatile, may be implemented using any one or more of static or dynamic RAM, a miniaturized internal disk drive, with associated disk-type medium, a hard drive, a flash memory or any other like memory medium and/or device internal to the exemplary portable data storage and display device 200. Similarly, fixed memory can be implemented using any one or more of ROM, PROM, EPROM, EEPROM, or compatible internal disk drive, or any other like memory storage medium and/or device.

It should be appreciated that, given the required inputs, the processing outlined in the disclosed systems and methods may be implemented through software algorithms, hardware or firmware circuits, or any combination of software, hardware and/or firmware control elements, present in the portable data storage and display device 200, or executable through such a device. This is particularly true regarding implementation of a switching network, device, hierarchy or unit which allows for automated or manual selection from among a plurality of data communication paths for transmission and reception of voice and/or data communications as may be implemented in, or through, the portable data storage and display device 200 at any given time, e.g., selection of data transfer via a data input/output interface 240, or data transfer via an incorporated satellite communication transceiver 280 (see FIG. 2), or data transfer via a portable satellite communication transceiver unit 380 (see FIG. 3).

It should be appreciated that, although not specifically depicted, virtually any conventional method and/or functionality by which voice and data communications may be effected in a single device for voice and data communications and control is contemplated. Exemplary embodiments disclosed regarding such voice and data communications may contemplate the inclusion in a single device of a satellite data communication transmission and reception capability. As discussed above, however, with reference to the exemplary embodiment in FIG. 3, a separate portable unit housing a satellite communication transceiver may incorporate a portion of the processing functions.

While exemplary embodiments have been described above, these exemplary embodiments should be viewed as illustrative, and not limiting. Various modifications, substitutes, or the like are possible to implement the systems and methods according to this disclosure.

What is claimed is:

1. A voice and data communication unit, comprising:
a satellite communication transceiver for facilitating at least one of voice or data communication from a portable data storage and display device to a remote receiving node via a communication satellite; and
a data input/output interface that provides a data communication pathway to send data to and receive data from the portable data storage and display device,
wherein no dimension of the satellite communication transceiver is larger that about four inches.

2. The system of claim 1, further comprising a satellite communication antenna connected to the satellite communication transceiver.

3. The system of claim 1, further comprising a power supply to power to at least one of the portable satellite communication transceiver or the data input/output interface.

4. The system of claim 1, wherein the data input/output interface comprises at least one of a wired, wireless or optical data communication path to facilitate transfer of data from or to the portable data storage and display device.

5. The system of claim 1, wherein the portable data storage and display device is an electronic data-generating device.

6. The system of claim 1, wherein the portable data storage and display device is an Electronic Flight Bag.

7. The system of claim 1, wherein the data comprises audio data related to a voice input to the portable storage and display device.

8. A method for facilitating voice and data communication via satellite, comprising:
obtaining a satellite communication transceiver with no dimension greater than about four inches; and
connecting a data input/output interface to the satellite communication transceiver as a combined unit,
wherein the combined unit facilitates at least one of voice or data communication between a portable data storage and display device and a remote receiving node via a communication satellite, the portable data storage and display device being in data communication with the combined unit via the data input/output interface.

9. The method of claim 8, further comprising connecting a satellite communication antenna to the satellite communication transceiver.

10. The method of claim 8, further comprising connecting a power supply to at least one of the portable satellite communication transceiver or the data input/output interface.

11. The method of claim 8, wherein the data input/output interface comprises at least one of a wired, wireless or optical data communication path to facilitate transfer of data between the portable data storage and display device and the combined unit.

12. The method of claim 8, wherein the portable data storage and display device is an electronic data-generating device.

13. The method of claim 8, wherein the portable data storage and display device is an Electronic Flight Bag.

14. The method of claim 8, wherein the data comprises audio data related to a voice input to the portable storage and display device.
